(19) United States
(12) Patent Application Publication
(10) Pub. No.: US 2011/0153808 A1
(43) Pub. Date: Jun. 23, 2011

(54) METHOD AND SYSTEM FOR PROVIDING A PERFORMANCE REPORT IN A WIRELESS NETWORK

(76) Inventors: JUNGSUB BYUN, San Ramon, CA (US); Zhi Li, San Ramon, CA (US); Raghvendra Savoor, Walnut Creek, CA (US)

(21) Appl. No.: 12/645,186

(22) Filed: Dec. 22, 2009

(51) Int. Cl. G06F 15/173

(52) U.S. Cl. 709/224

(57) ABSTRACT

A method and system for providing a performance report in a communication network are disclosed. For example, the method establishes a session with a mobile endpoint device, and monitors at least one performance parameter associated with the session by the mobile endpoint device. The method detects a termination of the session, and sends the performance report associated with the session to the communication network, wherein the performance report comprises information associated with the at least one performance parameter for the session.

The present disclosure relates generally to communication networks and, more particularly, to a method and system for providing a performance report in a wireless network.

### BACKGROUND

Dropped calls, poor conversation quality, and low data rate often impact the experience of cellular users. For example, a cellular user may simply redial a phone number when a call is dropped. Although the user is certainly not satisfied with the dropped call, the user is often left with very limited recourse to address such performance issues. Furthermore, there may be legitimate technical reasons as to why the cellular call was dropped. However, since the service provider of the cellular service is not made aware of the dropped call on a real-time basis, it is unable to address the customer's dissatisfaction or concerns. This may lead to continual customer dissatisfaction and may lead to a lost revenue for the service provider if the user decides to switch to a different cellular service provider due to the “perceived” poor quality of service.

### SUMMARY

In one embodiment, the present disclosure discloses a method and system for providing a performance report in a communication network. For example, the method establishes a session with a mobile endpoint device, and monitors at least one performance parameter associated with the session by the mobile endpoint device. The method detects a termination of the session, and sends the performance report associated with the session to the communication network, wherein the performance report comprises information associated with the at least one performance parameter for the session.

In another embodiment, the present disclosure discloses a method and system for processing a performance report in a communication network. For example, the method receives the performance report associated with a termination of a session from a mobile endpoint device, wherein the performance report comprises information associated with at least one performance parameter for the session, and processes the information associated with the at least one performance parameter for the session to determine at least one cause that has impacted the session. The method sends a response to the mobile endpoint device with the at least one likely cause.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network;

FIG. 2 illustrates an exemplary wireless access network;

FIG. 3 illustrates a flowchart of a method for providing a performance report;

FIG. 4 illustrates a flowchart of a method for providing a response to a performance report; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, an apparatus and a computer readable medium for providing a performance report in a wireless network, e.g., a cellular network. Although the present disclosure is discussed below in the context of a wireless access network and a packet network, e.g., an Internet Protocol (IP) Multimedia Subsystem (IMS) network, the present disclosure is not so limited. Namely, the present method and apparatus can be applied to any type of networks in which the present method can be deployed, and the like.

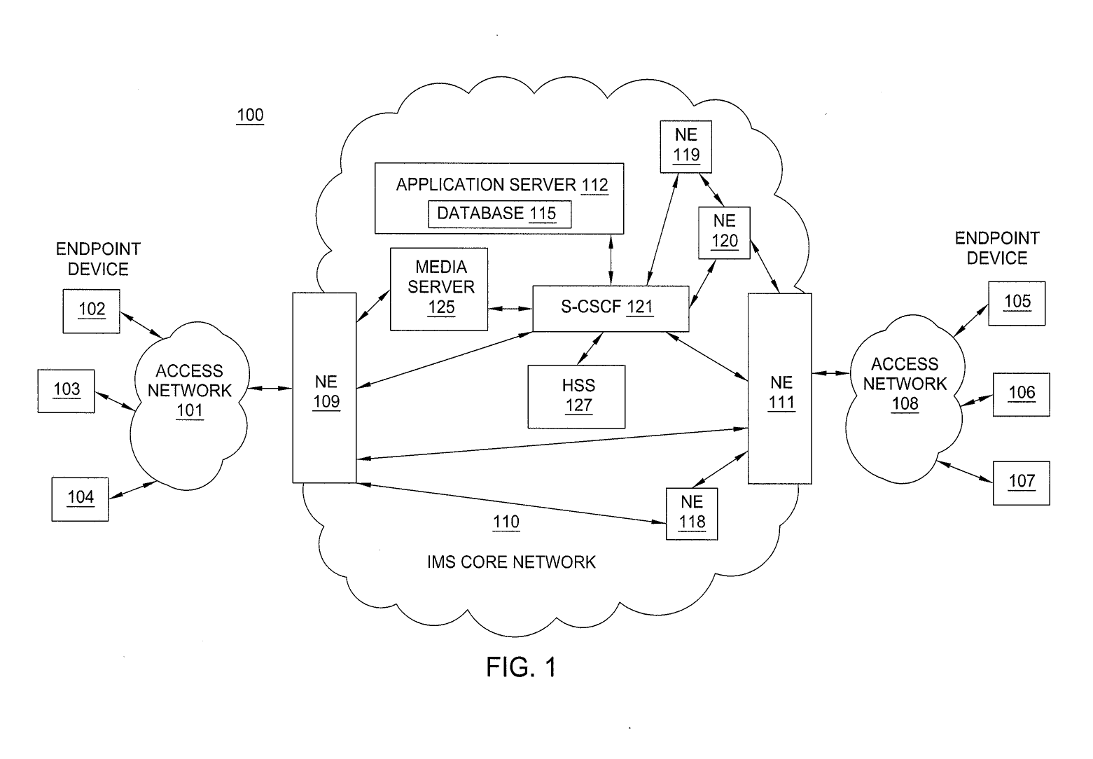

To better understand the present method and apparatus, FIG. 1 illustrates an example network 100, e.g., an Internet Protocol (IP) Multimedia Subsystem network related to the present disclosure. An IP network is broadly defined as a network that uses Internet Protocol to exchange data packets.

In one embodiment, the network 100 may comprise a plurality of endpoint devices 102-104 configured for communication with the core IMS network 110 (e.g., an IP based core backbone network supported by a service provider) via an access network 101. Similarly, a plurality of endpoint devices 105-107 are configured for communication with the IMS core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), mobile phones, smart phones, email devices, messaging devices, and the like. The access networks 101 and 108 serve as a conduit to establish a connection between the endpoint devices 102-107 and the Network Elements (NEs) 109 and 111 of the IMS core network 110. The access networks 101 and 108 may each comprise a Digital Subscriber Line (DSL) network, a broadband cable access network, a Local Area Network (LAN), a Wireless Access Network (WAN), a 3^{rd} party network, a cellular network and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy server, a border element, a firewall, a switch, and the like. An NE may also reside within the network (e.g., NEs 118-120) and may be used as a SIP server, a core router, or like device.

The IMS core network 110 also comprises a Home Subscriber Server (HSS) 127, a Serving—Call Session Control Function (S-CSCF) 121, a media server 125, and an Application Server 112 that contains a database 115. An HSS 127 refers to a network element residing in the control plane of the IMS network that acts as a central repository of all customer specific authorizations, service profiles, preferences, etc.

The S-CSCF 121 resides within the IMS core infrastructure and is connected to various network elements (e.g., NEs 109 and 111) using the Session Initiation Protocol (SIP) over the underlying IMS based core backbone network 110. The S-CSCF 121 may be implemented to register users and to provide various services (e.g., VoIP services). The S-CSCF interacts with the appropriate VoIP service related applications servers (e.g., 112) when necessary. The S-CSCF 121 performs routing and maintains session timers. The S-CSCF may also interrogate an HSS to retrieve authorization, service information, user profiles, etc. In order to complete a call that requires certain service specific features, the S-CSCF may need to interact with various application servers (e.g., various VoIP servers). For example, the S-CSCF may need to interact with another server for translation of an E.164 voice network address into an IP address, and so on.

The Media Server (MS) 125 is a special server that typically handles and terminates media streams to provide services such as announcements, bridges, and Interactive Voice Response (IVR) messages for VoIP service applications. The media server also interacts with customers for media session management to accomplish tasks such as process requests.

The application server 112 may comprise any server or computer that is well known in the art, and the database 115 may be any type of electronic collection of data that is also well known in the art. In one embodiment, the database 115 may store various performance reports received from mobile users, and real-time data and/or historical data pertaining to the performance of the wireless access network, as discussed in greater detail below. It should be noted that the communication system 100 may be expanded by including additional endpoint devices, access networks, network elements, application servers, etc. without altering the scope of the present disclosure.

The above IP network is described only to provide an illustrative environment in which packets for voice, data and multimedia services are transmitted on networks. The current disclosure discloses a method and system for providing a performance report, and/or a response to the receipt of the performance report in an exemplary communication network (e.g., an IMS network) illustrated in FIG. 1 and as described above.

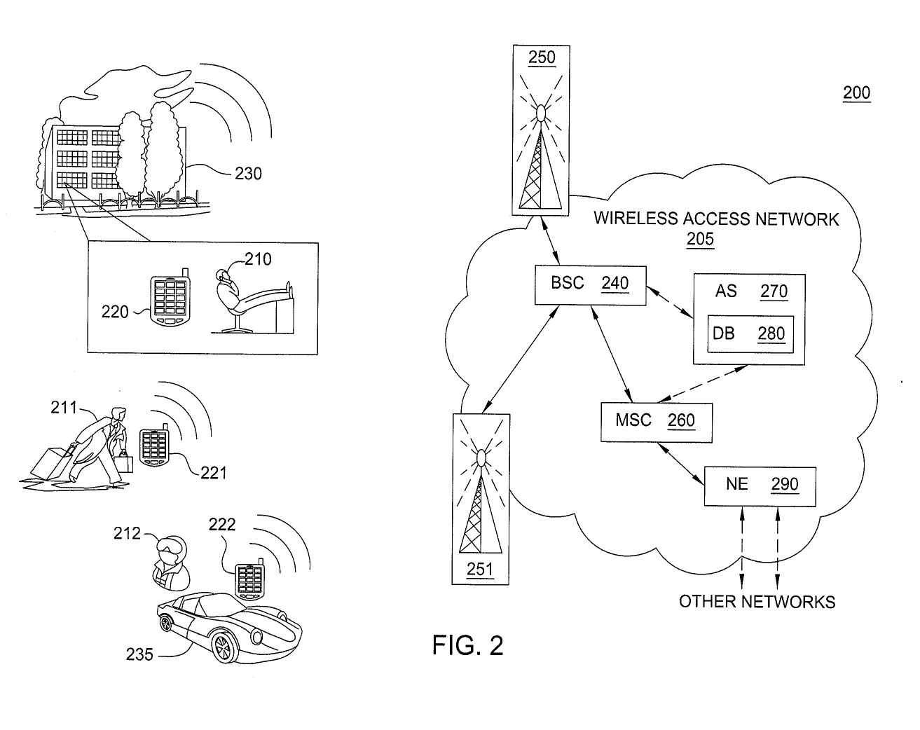

FIG. 2 illustrates an exemplary access network 200 suitable for implementing embodiments of the present disclosure for providing a performance report and/or a response to the receipt of the performance report. In one embodiment, the access network 200 comprises a wireless access network 205, e.g., a cellular network. Access networks 101 and 108 depicted in FIG. 1 may comprise, for example, a wireless access network 205 as shown in FIG. 2. Wireless access network 205 is configured to support wireless communication of users 210-212 via their respective wireless endpoint devices 220-222, with other wireless or wireline users. The link between wireless endpoint devices 220-222 and the wireless access network 205 comprises RF signals between the one or more base stations 250-251 and the wireless endpoint devices 220-222. Here only two base stations 250 and 251 are depicted. However, it should be appreciated that the wireless access network 205 may comprise any number of base stations depending upon the size and needs of the wireless access network. In addition, although only three users 210-212 and three wireless endpoint devices 220-222 are depicted, it should be appreciated that any number of users may be serviced at the same time by the wireless access network 205.

Each of the base stations 250-251 comprises, at a minimum, a RF transceiver, and is configured to receive and transmit RF signals to and from wireless endpoint devices (e.g., wireless endpoint devices 220-222). In one embodiment, the base stations 250-251 each includes a digital signal processor (DSP) that is capable of performing various performance measures, e.g., estimations of mobile endpoint device velocity, and the like.

As illustrated in FIG. 2, base stations 250-251 may support calls for a plurality of mobile users 210-212 who are using their wireless endpoint devices 220-222 in different environments, e.g., an indoor environment versus an outdoor environment. For example, user 210 may be engaged in a call supported by the base station 250 using endpoint device 220 while seated at an office desk inside the office building 230. User 211, on the other hand, may be outside walking while engaged in a call supported by the base station 250 using the wireless endpoint device 221. Finally, user 212 may be engaged in a call supported by the base station 251 using wireless endpoint device 222 while driving on a highway in the user's vehicle 235. Thus, user 210 can be broadly referred to as an indoor user, whereas users 211 and 212 can be broadly referred to as outdoor users in the above example.

It should be appreciated that the conditions in which the call sessions that are established for the three users 210-212 vary greatly. For example, the call session (broadly an established session or communication session that includes voice and/or non-voice data) for the mobile endpoint device 222 for user 212 may involve a handoff operation, if the user traverses from one cell coverage area to another cell coverage area. This may involve a switch over to a different base station, or even to a different service carrier, e.g., in a roaming mode. Similarly, the call session for the mobile endpoint device 221 for user 211 may experience a degradation in signal strength if the user 211 traverses behind a large structure or enters into a building, and so on. Thus, in one illustrative example, each of the users 210-212 may have a different experience due in part to their physical locations (e.g., whether they are indoor or outdoor, whether they are mobile or stationary, and so on). In another example, one user may be on a phone call, whereas another user is checking email, whereas another user is texting messages, and so on. Thus, in another illustrative example, each of the users 210-212 may have a different experience due in part to the functions or applications that are being executed on the mobile endpoint devices.

As illustrated in these two examples, if a call is dropped or if there is a degradation in the service (e.g., poor voice quality, slow data transmission rate, etc.), there may be one or more causes that contributed to the dropped call or degradation in service. In one embodiment, the causes may only be relevant or pertinent on a real-time basis (or more broadly on a per session basis, e.g., on a per call basis). Nevertheless, it would be beneficial if these causes can be made known to a user who may have expressed a dissatisfaction with the service, e.g., via a performance report that is sent from the mobile endpoint device. For example, the performance report can be sent by the user after the call is dropped (i.e., an abnormal termination) or after a normal termination of a call. Further details pertaining to the sending and processing of the performance report will be provided below.

Returning to FIG. 2, to manage the communications of multiple users serviced by the wireless access network 205, the wireless access network 205 may comprise one or more network elements. For example, the wireless access network 205 may comprise one or more base station controllers (BSCs) for managing RF communication of the base stations 250-251. Although only one BSC 240 is depicted in FIG. 2 it should be understood that any number of BCSs can be deployed. For example, each base station 250-251 could be serviced by its own BSC. BSC 240 performs a variety of wireless network management related tasks such as wireless channel assignments, determining transmission power levels, and controlling handovers from one base station to another base station, and the like.

In one embodiment, wireless access network 205 includes at least one mobile switching center (MSC) 260. Among other functions, the MSC 260 may maintain user profile records for users currently serviced by the base stations within the portion of the wireless access network that is the responsibility of MSC 260. For example, the MSC provides the information that is needed to support mobile service subscribers, such as user registration and authentication information. The MSC may also function as a media gateway and/or media gateway controller facilitating communication between the wireless access network 205 and other networks. For example, in a typical circuit-switched wireless communication systems, the MSC may connect the landline public switched telephone network (PSTN) system to the wireless communication system. Thus, the MSC 260 may be responsible for connecting calls from users 210-212 to other wireless users or to users on other networks such as the PSTN, VoIP networks, asynchronous transfer mode (ATM) or frame relay networks, etc via a network element 290.

In one embodiment, the wireless access network 205 may also include an application server 270. The application server 270 may include a database 280 suitable for storing various performance reports received from mobile users, and real-time data and/or historical data pertaining to the performance of the wireless access network, as will be described in greater detail below. The application server 270 may be configured to provide one or more functions supporting calls via the wireless access network 205. For example, application server 270 may comprise any server or computer that is well known in the art, and the database 280 may be any type of electronic collection of data that is also well known in the art.

Although the network elements deployed within the wireless access network 205 have been described as one or more discrete devices, it should be appreciated that the functionality described with respect to each network element is not limited to the particular device as described and depicted herein. Rather, the embodiment of FIG. 2 is merely illustrative of one wireless access network configuration that is suitable for implementing embodiments of the present disclosure. Thus, any other network elements providing the same functionality described herein with respect to the wireless access network 205 would be equally suitable for use in accordance with embodiments of the present disclosure. It should be noted that the wireless access network 205 may be expanded by including additional endpoint devices, base stations, BSCs, MSCs, network elements, application servers, etc. without altering the scope of the present disclosure.

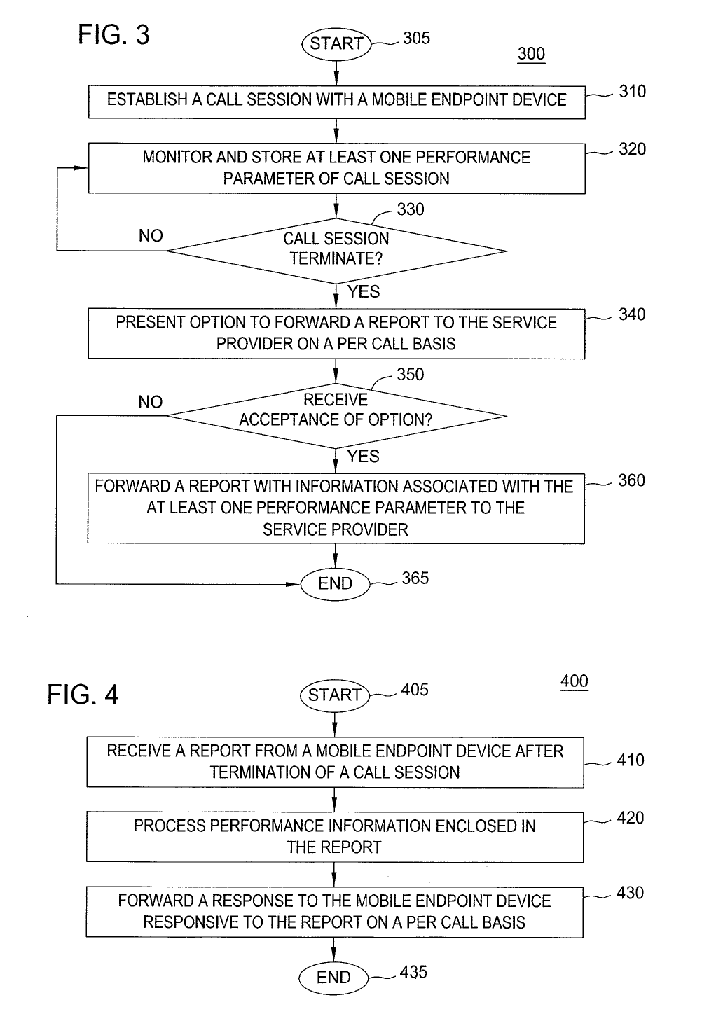

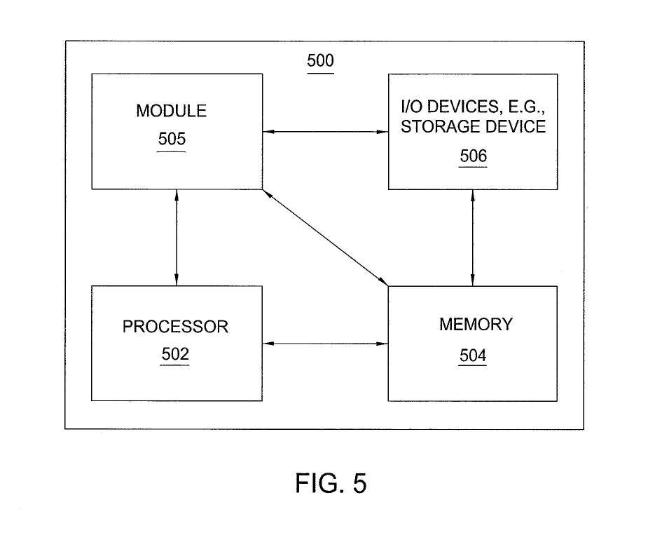

FIG. 3 illustrates a flowchart of a method for providing a performance report. For example, one or more steps of the method 300 can be performed by the mobile endpoint device 220-222 or broadly a general purpose computing device as disclosed in FIG. 5 below. In other words, a mobile endpoint device can be broadly represented by the device 500 of FIG. 5. The method begins in step 305 and proceeds to step 310.

In step 310, the method 300 established a call session with the mobile endpoint device. For example, an incoming call is made to the mobile endpoint device. Alternatively, an outgoing call is initiated via the mobile endpoint device.

In step 320, the method 300 monitors and stores performance information associated with at least one performance parameter associated with the call session. For example, performance parameters include but are not limited to one or more of: a spectral power density on a frequency channel, a received signal code power, a received signal strength, a block error rate, a spectral transit power, a timing difference between an uplink system frame and a downlink radio frame, an observed time difference between system frame numbers (SFN) for different base stations, a radio control connection count, and/or an active set (AS) count. It should be noted that the above list is only illustrative and is not exhaustive. Furthermore, one or more of the listed performance parameters can be monitored and stored, but it is not required that all of the listed performance parameters be monitored and stored. In one embodiment, a service provider may selectively define the pertinent performance parameters to be monitored and stored at the mobile endpoint device to meet the requirements of a particular deployment.

Furthermore, additional non-performance information can also be monitored and stored that is not related to performance. For example, information such as time (e.g., time stamps, or a time duration, etc.), date, configuration settings of the mobile endpoint device (e.g., firmware version, access technology, encoding/decoding technology or codes, IDs and the like), and/or geo-location information (e.g., latitude, longitude). In one embodiment, the non-performance information is associated with the monitored performance parameters. For example, the mobile endpoint device may associate a time when a call is dropped, or geo-location information when a call is dropped and so on.

In step 330, method 300 determines whether the call session has terminated. If the query is negatively answered, then method 300 returns to step 320 to continue monitoring the at least one performance parameter. If the query is positively answered, then method 300 proceeds to step 340. It should be noted that the session termination can be deemed an abnormal session termination or a normal session termination. An abnormal session termination is broadly a termination that was not initiated by the called party or the calling party, e.g., a dropped or interrupted call. A normal session termination is broadly a termination that was initiated by the called party or the calling party, e.g., receiving an indication or input from called party or the calling party to terminate the session.

In step 340, method 300 presents an option to the user via the mobile endpoint device to forward a performance report to the service provider network. For example, at the end of a call session, an application running on the mobile endpoint device may present a message (either audibly via a speaker or visibly via a display), “Would you like to forward a performance report for this session to the service provider?”. It should be noted that this displayed message is only illustrative and that any number of different messages can be displayed. For example, if the termination is deemed to be abnormal, method 300 may present the message, “Would you like to report this dropped call?”. In one embodiment, the performance report message is only presented to the user only if the termination is deemed to be abnormal. In another embodiment, the performance report message is always presented to the user at the end of each session termination. This will allow the user an opportunity to report a problem that may not be a dropped call, e.g., a poor connection with poor sound quality, a session where the transmission rate is poor, and so on.

In step 350, the method 300 determines whether an acceptance of the option to forward a performance report to the service provider network is received. For example, the mobile endpoint device may receive an input (e.g., a simple “yes” or “no” response) from the user, e.g., via inputs from a keypad or inputs via a touch screen. If the query is negatively answered, then method 300 ends in step 365. If the query is positively answered, then method 300 proceeds to step 360. In one embodiment, if no response is received, the method 300 will assume the response is “no” and ends in step 365.

In step 360, method 300 sends the performance report to the service provider network. For example, the mobile endpoint device generates and forwards a performance report or message that includes the information associated with the at least one performance parameter that was monitored and recorded during the established session. In one embodiment, the performance report or message also includes additional non-performance information that was monitored and recorded during the established session. For example, the start time and end time of the established session, the duration of the established session, and the geo-location of the mobile endpoint device can be sent along with the performance report or message. In one embodiment, the performance report or message is received and processed by the application server 112 of the core network. In another embodiment, the performance report or message is received and processed by the application server 270 of the wireless access network. The method ends in step 365.

FIG. 4 illustrates a flowchart of a method 400 for providing a response to a received performance report. For example, one or more steps of the method 400 can be performed by the application server 112, application server 270, or broadly a general purpose computing device as disclosed in FIG. 5 below. In other words, an application server can be broadly represented by the device 500 of FIG. 5. The method begins in step 405 and proceeds to step 410.

In step 410, method 400 receives a performance report or message from a mobile endpoint device, e.g., by an application server. In one embodiment, the performance report or message is received upon termination of an established session. Thus, the performance report or message is received on a per session basis.

In step 420, the method 400 processes the performance information and/or non-performance information that were included with the performance report or message. More specifically, method 400 processes the enclosed information to determine whether the measured metrics of the established session was within acceptable performance criteria. It should be noted that the analysis not only utilizes the performance information and/or non-performance information enclosed in the performance report or message, but it may also utilize historical information and other real-time information.

To illustrate, the method 400 may deduce from the performance report or message that it was sent due to a dropped call. For example, the performance report or message may include the performance parameter of the received signal strength as monitored during the established session. The performance report or message may also include the geo-location information of the mobile endpoint device. Using this set of information as an example, the analysis performed by method 400 may arrive to a conclusion that the geographic location as reported by the performance report or message is an area that is known (e.g., from historical data) to have poor cellular coverage, e.g., existence of large natural or man-made obstructions, or there is insufficient cell tower coverage, and the like. This conclusion may also be confirmed from the fact that the monitored received signal strength from the established session was decreasing as the user was approaching the area in which the call was dropped. In this illustrative example, the method 400 may arrive to the conclusion that the established session was terminated abnormally due to the fact that the user entered an area where there was poor cellular coverage. This caused the call to be dropped when the received signal strength fell below a critical point where the established session can no longer be sustained.

It should be noted that the above example is only illustrative. The analysis may process other performance parameters as listed above. For example, the analysis may assess the attenuation on the radio channel (e.g., transmit power of base station—received power) to evaluate the cause for path loss. In another example, the analysis may assess the downlink block error rate to determine whether it may have contributed to poor voice quality. As such, numerous assessments can be made to determine one or more potential causes that could affect an established session. Broadly, the following issues may be of interest to a mobile user, e.g., coverage, dropped calls, blocked calls (e.g., call origination failures), throughput, and/or voice quality. As such, in one embodiment performance parameters affecting any one of these issues can be investigated to determine whether a cause can be identified that has negatively impacted a user's established session. Of course, the analysis may also reveal that there was no cause that negatively impacted the session.

In step 430, the method 400 forwards a response or a reply to the mobile endpoint device that is responsive to the performance report or message on a per established session basis, e.g., on a per call basis. For example, the method 400 may determine that a dropped call was the likely result that the user has entered an area with poor coverage while the session was established. The method 400 then generates and forwards a response or reply that includes an explanation (broadly a likely cause that impacted the session) for the dropped call indicating that the user has previously entered an area with poor coverage. The response or reply may optionally include a recommendation, e.g., recommending that the user should traverse in a certain direction while in that particular area so that a minimum signal strength is maintained to minimize the possibility of a call being dropped and so on. Alternatively, if the mobile endpoint device has multiple access technologies (e.g., cellular capability and Wi-Fi capability), the recommendation may recommend the use of Wi-Fi access in the area with poor cellular coverage, and so on. The response is sent as soon as possible relative to the performance report or message being received. In other words, the service provider should strive to provide the response as soon as possible (e.g., near real time) upon arriving at a proper assessment for the cause of an abnormal termination. Thus, the mobile endpoint device will receive a response or a reply from the service provider network on a per session basis as to the cause of a dropped session or a session with poor quality. The method ends in step 435.

The methods of the present disclosure allow a user of a mobile endpoint device to immediately provide feedback to a service provider on a per established session basis, e.g., on a per call basis. In one embodiment, the reporting can be automatically triggered at the end of a session. Furthermore, upon receiving the performance report, the service provider is given an opportunity to immediately trouble shoot any issues that may have caused the user to have a negative experience. More importantly, it allows a service provider to immediately provide a cause and/or a recommendation to address the network issue experienced by the user. In turn, the user will feel that his or her concerns are being quickly addressed, thereby leading to greater customer satisfaction with the mobile services provided by the server provider.

It should be noted that although not specifically specified, one or more steps of methods 300 and 400 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIGS. 3 and 4 that recite a determining operation or involve a decision, do not necessarily require that both branches of the determining operation be practiced. In other words, one of the branches of the determining operation can be deemed as an optional step.

FIG. 5 depicts a high-level block diagram of a general-purpose computer or computing device suitable for use in performing the functions described herein. As depicted in FIG. 5, the system 500 comprises a processor element 502 (e.g., a CPU), a memory 504, e.g., random access memory (RAM) and/or read only memory (ROM), a module 505 for providing a performance report, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present method can be implemented in software and/or in a combination of software and hardware, e.g., using application specific integrated circuits (ASIC), a general purpose computer or any other hardware equivalents. In one embodiment, the present module or process 505 for providing a performance report can be loaded into memory 504 and executed by processor 502 to implement the functions as discussed above. As such, the present method 505 for providing a performance report (including associated data structures) of the present disclosure can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a performance report in a communication network, comprising:
establishing a session with a mobile endpoint device;
monitoring at least one performance parameter associated with the session by the mobile endpoint device;
detecting a termination of the session; and
sending the performance report associated with the session to the communication network, wherein the performance report comprises information associated with the at least one performance parameter for the session.

2. The method of claim 1, wherein said communication network comprises a wireless access network.

3. The method of claim 2, wherein the wireless access network is in communication with an Internet Protocol (IP) network.

4. The method of claim 3, wherein the performance report is received by an application server deployed in the Internet Protocol (IP) network.

5. The method of claim 2, wherein the performance report is received by an application server deployed in the wireless access network.

6. The method of claim 1, wherein the at least one performance parameter comprises at least one of: a spectral power density on a frequency channel, a received signal code power, a received signal strength, a block error rate, a spectral transit power, a timing difference between an uplink system frame and a downlink radio frame, an observed time difference between system frame numbers (SFN) for different base stations, a radio control connection count, and/or an active set (AS) count.

7. The method of claim 1, wherein the performance report further comprises non-performance information.

8. The method of claim 7, wherein the non-performance information comprises at least one of: time information, date information, configuration information, or geo-location information.

9. The method of claim 1, further comprising:
presenting an option to forward the performance to a user of the mobile endpoint device prior to sending the performance report.

10. The method of claim 1, wherein the option is presented only for a termination that is deemed to be abnormal.

11. The method of claim 1, wherein the option is presented at a termination of each and every session.

12. A method for processing a performance report in a communication network, comprising:
receiving the performance report associated with a termination of a session from a mobile endpoint device, wherein the performance report comprises information associated with at least one performance parameter for the session;
processing the information associated with the at least one performance parameter for the session to determine at least one cause that has impacted the session; and
sending a response to the mobile endpoint device with the at least one likely cause.

13. The method of claim 12, wherein said communication network comprises a wireless access network.

14. The method of claim 13, wherein the wireless access network is in communication with an Internet Protocol (IP) network.

15. The method of claim 14, wherein the performance report is received by an application server deployed in the Internet Protocol (IP) network.

16. The method of claim 13, wherein the performance report is received by an application server deployed in the wireless access network.

17. The method of claim 12, wherein the at least one performance parameter comprises at least one of: a spectral power density on a frequency channel, a received signal code power, a received signal strength, a block error rate, a spectral transit power, a timing difference between an uplink system frame and a downlink radio frame, an observed time difference between system frame numbers (SFN) for different base stations, a radio control connection count, and/or an active set (AS) count.

18. The method of claim 12, wherein the performance report further comprises non-performance information.

19. The method of claim 18, wherein the non-performance information comprises at least one of: time information, date information, configuration information, or geo-location information.

20. The method of claim 12, wherein the response comprises a recommendation to address the at least one cause.
